(19) United States
(12) Patent Application Publication
(10) Pub. No.: US 2009/0188523 A1
(43) Pub. Date: Jul. 30, 2009

(54) Structure of floss stick having a strip-shaped floss

(76) Inventor: Wen Chin Rau, Bali Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/010,331

(22) Filed: Jan. 24, 2008

(51) Int. Cl. A61C 15/04

(52) U.S. Cl. 132/324

(57) ABSTRACT

An improved structure of floss stick includes a body, two forks extended from a side of the body, and a strip-shaped floss with a predetermined width having two ends stretched and fixed respectively to a position close to a free end of the two forks. When using the floss stick, the strip-shaped floss is put through a teeth interstice of a user for making surface contact between the strip-shaped floss and teeth at both sides of the teeth interstice, in order to increase cleaning range of the floss, and save time of teeth cleaning.

### FIELD OF THE INVENTION

The present invention relates to an improved structure of a floss stick, in particular to a floss stick having a flat strip-shaped floss.

### BACKGROUND OF THE INVENTION

Floss stick is a common tool for teeth cleaning. Regular floss stick sold on the market has a stick body with a floss on it. When flossing by a conventional floss stick, the floss is pressed into the teeth interstice to move to and fro on the teeth surface for scratching out food or sordes from the teeth. Generally, the structure of the conventional floss stick comprises two parallel forks extending from a side of the body, and the two ends of a floss are stretched across the free ends of the forks. The floss may be made of cotton or rayon, and is round in shape.

For example, FIG. 1 shows a schematic view of a conventional floss stick. The floss stick 1 comprises two parallel forks 12, 13 extending downward from a side of a body 11. Through holes 21, 22 are oppositely arranged at positions near the free ends of the forks 12, 13, for connecting and fastening two ends of a round floss 2, respectively.

A handle 14 is extended from the body 11, which is shaped to be held by a user for flossing the teeth and removing food from the teeth.

The conventional floss stick only comprises a single floss. When flossing, there is only one floss passing through the teeth interstice, and the contact area between the floss and the tooth is limited and small as a spot. Accordingly, when flossing the teeth surface at both sides of the teeth interstice with a single floss, the user has to spend longer time to move the floss stick to and fro more times in order to increase contact between the floss and the teeth, for achieving better cleaning effect.

Furthermore, because everyone's teeth arrangement is different, when pressing a single floss into the teeth interstice, the user need to adjust the angle of the floss stick to make contact between the floss and tooth for scratching out sordes.

In addition, the floss is usually made of cotton or rayon, and the round floss is stretched and fixed to the two forks of the body of the floss stick. Because the user moves the floss to and fro between the teeth, the frequent abrasion easily causes the breakage of the floss.

The floss of the conventional floss stick is a single round floss fixed to the forks of the floss stick. If the floss is too thick, it's not easy to press the floss into the teeth interstice, and it may enlarge the teeth interstice thereafter, which will affect teeth arrangement. Besides, thick floss cannot move smoothly in the teeth interstice, and thus the scratched sordes is not easy to remove from the teeth interstice, and therefore the cleaning effect is poor.

In contrast, if the floss is too thin, the breakage of the floss happens more often, therefore, not only the sordes will keep remaining in the teeth interstice without being cleaned, but the reaction force of the forks will directly apply to the gum to cause injury.

### SUMMARY OF THE INVENTION

A primary object of the present invention is to provide a floss stick having a flat strip-shaped floss. The flat strip-shaped floss provides large contact area between floss and teeth, enabling the user to simultaneously clean different area of the teeth. Hence, the cleaning effect is enhanced and good cleaning can be achieved in short time.

Another object of the present invention is to provide a floss stick having a flat strip-shaped floss that is easy for use. The strip-shaped floss is made of plural lengths of fiber wires which is soft. The user can easily push the floss through the teeth and clean the teeth surfaces at both sides of the teeth interstice. There is no need to adjust the angle of the floss stick.

A further object of the present invention is to provide an improved structure for floss stick that has good toughness against abrasion or pulling. The floss stick comprises a flat strip-shaped floss made of plural lengths of fiber wires. The tight arrangement of the fiber wires renders good toughness against abrasion or pulling.

To achieve the above objects, the present invention provides an improved structure of a floss stick. The floss stick includes a body, two forks extending from a side of the body, and a strip-shaped floss with a predetermined width having two ends stretched and fixed respectively to a position close to a free end of the two forks. When using the floss stick, the strip-shaped floss is put through a teeth interstice of a user for making surface contact between the strip-shaped floss and teeth at both sides of the teeth interstice, in order to increase cleaning area of the floss, and save time of teeth cleaning.

Because the floss of the present invention is a flat strip-shaped floss, when the user presses the floss into teeth interstice for flossing, the flat strip-shaped floss simultaneously contacts different areas of the teeth, therefore increasing the contact area between the floss and the teeth. The user does not need to spend long time to move the floss stick to and fro more times in order to increase contact chance between the floss and the teeth. Therefore, the present invention provides a more effective way for teeth cleaning, improves flossing efficiency, and further saves time for flossing.

In addition, since the flat strip-shaped floss of the present invention is made of soft fiber, no matter what angle the user puts the floss into teeth interstice, the strip-shaped floss will always contact with the teeth without adjusting angle of the floss stick intentionally.

The present invention installs a flat strip-shaped floss on the body of the floss stick. In contrast to the conventional design of single round floss, the overall strip-shaped floss has bigger strength for avoiding breakage of floss during use.

### BRIEF DESCRIPTION OF THE DRAWINGS

FIG. 1 shows a schematic view of a conventional floss stick;

FIG. 2 shows a schematic view of an improved structure of a floss stick in accordance with a first embodiment of the present invention;

FIG. 3 shows a cross-sectional view taken along line 3-3 of FIG. 2;

FIG. 4 shows a cross-sectional view taken along line 3-3 of an improved structure of a floss stick according to a second embodiment of the present invention; and

FIG. 5 shows a perspective view that the floss stick of the present invention is used to floss a user's teeth.

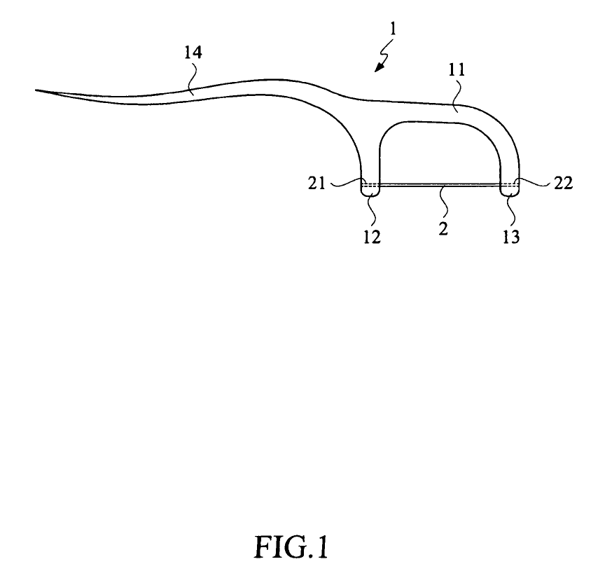

### DETAILED DESCRIPTION OF THE PREFERRED EMBODIMENTS

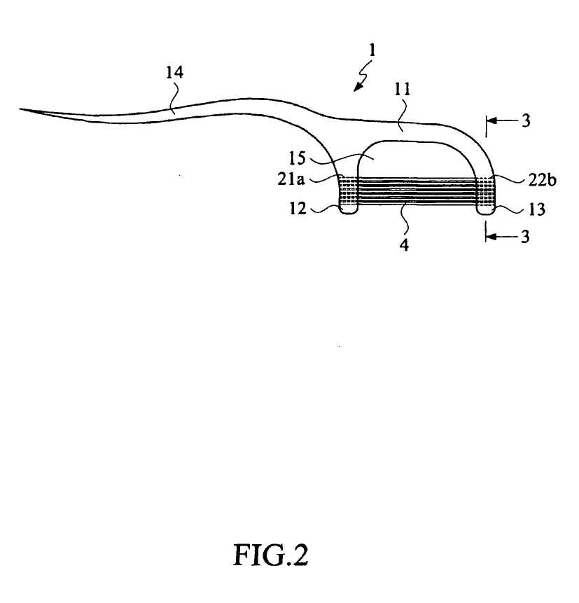

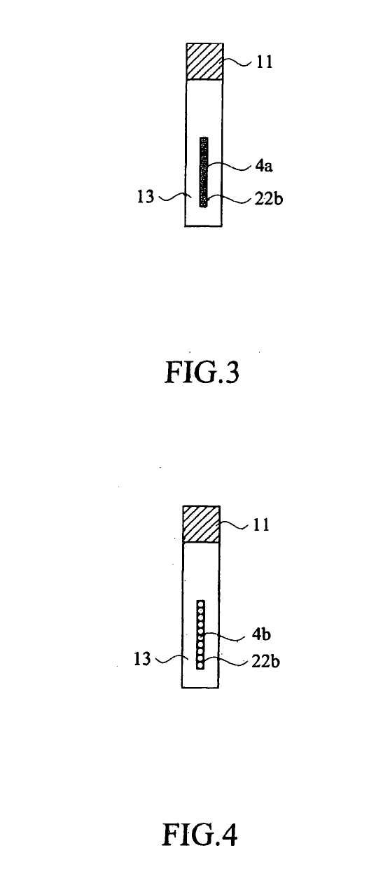

Please refer to FIGS. 2 and 3. FIG. 2 shows a schematic view of an improved structure of a floss stick in accordance with a first embodiment of the present invention. FIG. 3 shows a cross-sectional view taken along line 3-3 of FIG. 2. The floss stick, generally designed with reference numeral 1, comprises a body 11 arranged at a front part of the floss stick 1, and two forks, namely, a first for 12 and a second fork 13, are extended downward from a side of the body 11. The first fork 12 is spaced with a predetermined distance from the second fork 13.

Two holes 21a, 22b are respectively and oppositely arranged at a position near the free end of the first fork 12 and that of the second fork 13. Both ends of a strip-shaped floss 4 pass through the holes 21a and 22b respectively for fixing the strip-shaped floss 4 to the first fork 12 and second fork 13.

The strip-shaped floss 4a on the floss stick 1 is originally a thick floss with a large diameter, and the thick floss is pressed with high pressure to become flat in shape and has a larger width. Each of a plurality of the fiber wires of the thick floss links to each other to form a strip shape. The strip-shaped floss 4a is horizontally and parallely arranged along the lengthwise direction of the body 11. The flosses 4a is stretched and fixed in the corresponding holes at the first and second forks 12, 13. There is a space 15 defined by the strip-shaped floss 4a, the first fork 12, the second fork 13 and the body 11.

As shown in FIG. 4, it shows a cross-sectional view taken along line 3-3 of an improved structure of a floss stick according to a second embodiment of the present invention. The improved structure of the floss stick 1 is similar to that of the first embodiment, and the same reference numerals are used to identify elements that are similar or identical in the two embodiments, except that in the second embodiment, the floss on the floss stick 1 is formed by a plurality of thin flosses with small diameter, and each of the plurality of thin floss is adjacent to each other to form a strip-shaped floss 4b with a predetermined width. Each of the plurality of thin flosses is stretched and fixed in the corresponding holes of the first fork 12 and the second fork 13, wherein a predetermined distance between two adjacent flosses is kept.

A handle 14 is extended laterally from the body 11 for the use of being held by a user.

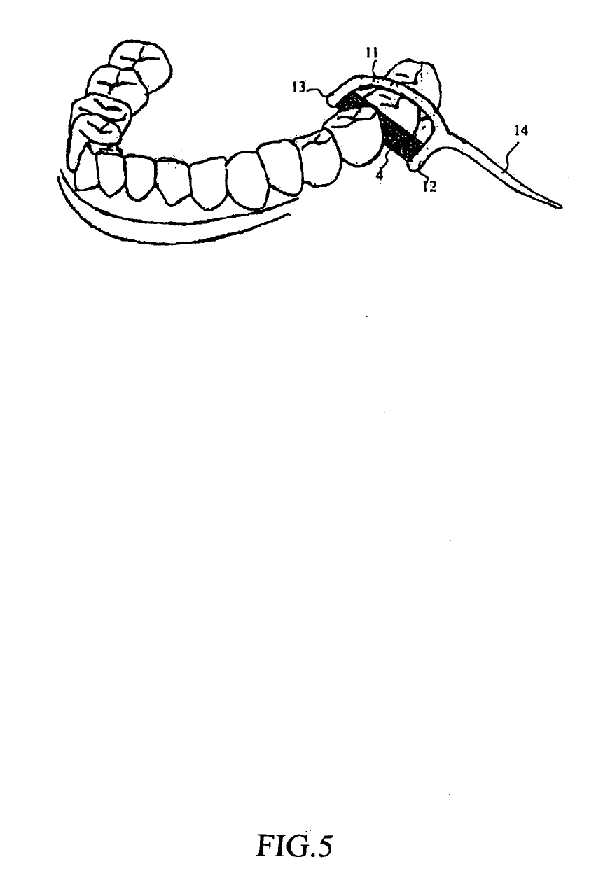

As shown in FIG. 5, when the user holds the handle 14 and puts the strip-shaped floss 4 through the teeth interstice, the strip-shaped floss 4 has a big contact area with teeth at the both sides of the teeth interstice. As moving the floss stick to and fro, the strip-shaped floss 4 continuiously scratches the sordes on the teeth in a wide range. The scratched sorder is moved with the floss stick, and then attached to the fiber wires or adjacent thin flosses of the strip-shaped floss. And the sordes will be removed from the teeth interstice as soon as the user puts the floss stick 1 out of the teeth interstice.

While the invention has been described in connection with what is presently considered to the most practical and preferred embodiments, it is to be understood that the invention is not to be limited to the disclosed embodiments, but on the contrary, is intended to cover various modifications and equivalent arrangement included within the spirit and scope of the appended claims.

What is claimed is:

1. A floss stick comprises:
a body;
two forks, which are extended from one side of the body, and the two forks are spaced from each other with a predetermined distance;
a plurality of fiber wires, each of which is stretched with two ends and fixed respectively to a position close to a free end of the two forks, and each of the fiber wires is adjacent to each other to form a strip-shaped floss with a predetermined width.

2. The floss stick as claimed in claim 1, wherein a handle is extended from the body.

3. A floss stick comprises:
a body;
two forks, which are extended from one side of the body, and the two forks are spaced from each other with a predetermined distance;
a plurality of flosses, each of which is stretched with two ends and fixed respectively to a position close to a free end of the two forks, and each of the flosses is adjacent to each other to form a strip-shaped floss with a predetermined width.

4. The floss stick as claimed in claim 3, wherein a handle is extended from the body.
